(19) United States
(12) Patent Application Publication
(10) Pub. No.: US 2026/0025225 A1
(43) Pub. Date: Jan. 22, 2026

(54) SOFT METRIC BASED BIT ERROR CORRECTION WITH CRC CODES

(71) Applicant: Cypress Semiconductor Corporation, San Jose, CA (US)

(72) Inventors: Stefano Marsili, Faak am See (AT); Giuseppe Li Puma, Bochum (DE); Robert Zopf, Rancho Santa Margarita, CA (US); Adam Weisi, Heiligenhaus (DE); Claudio Rey, Chandler, AZ (US)

(73) Assignee: Cypress Semiconductor Corporation, San Jose, CA (US)

(21) Appl. No.: 18/775,908

(22) Filed: Jul. 17, 2024

(51) Int. Cl. H04L 1/00; H04L 1/20; H04W 4/80

(52) U.S. Cl. CPC H04L 1/0045; H04L 1/0091; H04L 1/203; H04W 4/80

(57) ABSTRACT

Disclosed are methods and systems for a Bluetooth Low Energy (BLE) receiver to reduce the number of retransmission of packets needed to receive an error free packet. A softbit metric of a demodulator may be used to identify likely bit error positions of a corrupted packet and to correct bits of the corrupted packet corresponding to the identified bit error positions. When a demodulated packet fails the CRC, a receiver may identify one or more hypothesized bit error positions for the demodulated bits of the packet based on the softbit metric. The receiver may flip one or more of the demodulated bits corresponding to the hypothesized bit error positions. The receiver may determine if the packet after flipping the demodulated bits passes the CRC. If the CRC passes, the hypothesized bit error positions identifies the bit error positions of the corrupted packet and the receiver has corrected the bit errors.

### TECHNICAL FIELD

The subject technology generally relates to wireless communication systems, and more particularly, to systems and methods for correcting bit errors in wireless communication systems such as a Bluetooth® network.

### BACKGROUND

Bit errors are a hallmark of wireless communication links. Bit errors may be broadly categorized as random errors or burst errors. Random bit errors are evenly distributed across transmission packets in time and may be caused by a persistent channel impairment, such as a weak signal due to physical barriers or a long distance link. Bursty bit errors are localized in time and may be caused by a transient condition such as an interfering transmission or intermittent channel congestion. Many wireless communication systems or protocols, such as Bluetooth Low Energy (BLE), do not include error correction and instead use retransmissions to achieve a reliable communication link between a transmitter and a receiver. Such systems conventionally discard corrupted transmissions and rely on error-free reception of a subsequent retransmission. It is assumed that retransmission may combat low levels of random bit errors, (i.e., an error-free packet is received after some reasonable number of retransmission).

However, the likelihood of receiving an error-free packet quickly drops with increasing packet size and bit error rate (BER), resulting in a significant increase in the number of retransmissions. Several retransmissions may be necessary to overcome even low random BER. The number of retransmissions may have a negative impact on delay and power requirements. In addition, real-time or two-way audio or video wireless links are delay sensitive and may limit the number of retransmissions.

One way to reduce BER and the number of retransmissions is to improve the sensitivity of a receiver, which may be achieved by reducing the noise figure of the analog front-end and designing the demodulator for the lowest required signal to noise ratio (SNR). However, reducing the noise figure of the analog front-end increases the current consumption at the expense of a shortened battery life. Designing the demodulator for the lowest required SNR also increases design complexity, size, and power. It is desirable to improve the sensitivity of the receiver with less negative trade-offs.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an example wireless network architecture, in accordance with some embodiments of the present disclosure.

FIG. 2 illustrates a block diagram of a receiver 200 to flip demodulated bits to correct bit errors based on hypothesized bit error positions within a packet, in accordance with some embodiments of the present disclosure.

FIG. 3 illustrates a plot of bit positions in a packet hypothesized to have a high probability of bit errors based on a softbit metric for a BPSK modulated signal in accordance with some embodiments of the present disclosure.

FIG. 4 illustrates a processing model of a packet from a data source to a receiver that attempts to correct bit errors in the demodulated packet based on hypothesized bit error positions, in accordance with some embodiments of the present disclosure.

FIG. 5 illustrates a block diagram of a demodulator with a decision feedback equalizer that has a high probability of producing consecutive bit errors correctable by flipping two consecutive bits based on hypothesized bit error positions, in accordance with some embodiments of the present disclosure.

FIG. 6(A) illustrates a plot of bit positions for a pair of bit errors in a packet of demodulated bits produced by a demodulator with a decision feedback equalizer, in accordance with some embodiments of the present disclosure.

FIG. 6(B) illustrates the softbit metric corresponding to the demodulated bits of the packet of FIG. 6(A) produced by the demodulator with a decision feedback equalizer, in accordance with some embodiments of the present disclosure.

FIG. 7 illustrates a flow diagram of a method to correct single or two consecutive bit errors in the demodulated bits of a packet based on hypothesized bit error positions, in accordance with some embodiments of the present disclosure.

FIG. 8 illustrates a block diagram of a technique to identify bit error positions based on a comparison of CRC of a demodulated packet and permutations of CRC derived from precomputed syndromes for a 1-bit error in different bit positions within a packet, in accordance with some embodiments of the present disclosure.

FIG. 9 illustrate a block diagram of a technique to identify bit error positions based a comparison of CRC of a demodulated packet and permutations of CRC derived from precomputed syndromes for two consecutive bit errors in different bit positions within a packet, in accordance with some embodiments of the present disclosure.

FIG. 10 illustrates a block diagram of a technique to identify bit error positions based a comparison of CRC of a demodulated packet and an exhaustive search of CRC derived from precomputed syndromes for two consecutive bit errors in different bit positions within a packet, in accordance with some embodiments of the present disclosure.

FIG. 11 illustrates a flow diagram of a method to correct one or more bit errors in the demodulated bits of a packet based on hypothesized bit error positions derived from softbit metrics for the bits, in accordance with some embodiments of the present disclosure.

FIG. 12 is a block diagram of a Bluetooth device showing hardware and software drivers with CRC processing assisted by a softbit metric of the demodulator to correct bit errors within a packet, in accordance with some embodiments of the present disclosure.

### DETAILED DESCRIPTION

Examples of various aspects and variations of the subject technology are described herein and illustrated in the accompanying drawings. The following description is not intended to limit the invention to these embodiments, but rather to enable a person skilled in the art to make and use this invention.

Bluetooth Low Energy (BLE), like most wireless communication systems/protocols, uses retransmission to achieve a reliable communication link. When a corrupted packet is received such as when the packet fails the cyclic redundancy check (CRC), the receiver may request the source of the packet to retransmit the packet. As the packet size or the bit error rate (BER) increases, the number of retransmissions required to receive an error-free packet may increase significantly. Aspects of the subject technology disclosed herein reduce the number of retransmissions needed to reconstruct an error-free packet, thereby improving channel throughput, increasing communication range, and reducing latency and power consumption. While aspects of the subject technology are described in the context of BLE, it is understood that the subject technology is applicable to other wireless networks running packet based protocol including but not limited to cellular networks (e.g., Long-Term Evolution (LTE) networks), wireless local area networks (WLANs), wireless sensor networks and satellite communication networks.

In one embodiment, techniques to reduce the number of retransmissions may use a softbit quality metric of a demodulator to identify likely bit error positions of a corrupted packet and to correct bits of the corrupted packet corresponding to the identified bit error positions. The softbit quality metric for a bit of a received packet, also referred to as softbit metric, quality metric, or simply softbit, may indicate the probability of a demodulated bit error for the bit. A demodulator may generate the softbit metric for each bit of a packet to identify candidate bit positions for demodulated bits that have a high probability of a wrong bit decision. When a demodulated packet fails the CRC, a receiver may flip one or more bits of the demodulated packet corresponding to the candidate bit positions. The receiver may determine if the flipped bits correct the bit errors by running the CRC on the demodulated packet with the flipped bits.

In one embodiment, the receiver may hypothesize that a packet has a single bit error by flipping only one bit of the demodulated packet corresponding to a candidate bit error position. If the demodulator identifies N candidate bit error positions that have a high probability of a bit error based on the softbit metric, there may be N candidate error-free packets to check, each candidate error-free packet flipping a single bit at a different candidate bit error position. The receiver may run the CRC on the N candidate error-free packets to determine if any candidate bit error position correctly identifies the bit error of the originally demodulated packet. If a candidate error-free packet passes the CRC, the receiver has successfully corrected the single bit error in the originally demodulated packet at the corresponding candidate bit error position.

In one embodiment, the receiver may hypothesize that a packet has double bit errors by flipping two bits of the demodulated packet based on the candidate bit error positions. In one embodiment, if the demodulator has a decision feedback architecture, bit errors has a tendency to occur in pairs. For example, due to the decision feedback, a demodulated error could trigger a second error on the next demodulated bit. The demodulator may identify N candidate bit error positions that have a high probability of a bit error based on the softbit metric. Each candidate bit error position may correspond to a first bit of a pair of bit errors. The receiver may flip two consecutive bits starting from each candidate bit error position to generate N candidate error-free packets, each candidate error-free packet flipping two consecutive bits at a different pair of bit positions. The receiver may run the CRC on the N candidate error-free packets to determine if any pair correctly identifies the double bit errors of the originally demodulated. If a candidate error-free packet passes the CRC, the receiver has successfully corrected the double bit errors in the originally demodulated packet.

In one embodiment, the receiver may hypothesize that a packet has double bit errors by flipping two consecutive bits of the demodulated packet without the knowledge of the likely bit error positions derived from the softbit metric. The technique may precompute the error syndromes for all possible positions of two consecutive bit errors. For example, the error syndromes may be pre-computed by feeding the CRC checker with a sequence of all 0's and two consecutive bits set to 1 at different target bit error positions in the packet. The technique may sort the pre-computed syndromes in ascending order to store in a look-up-table together with information of the bit positions of the two 1's representing the bit error. When a demodulated packet fails the CRC, the CRC checksum is searched inside the look-up-table to determine if there is a match with an error syndrome. If a match is found, the receiver may flip the two consecutive bit errors indicated by the corresponding positions of the two 1's for the matching error syndrome.

In one embodiment, the receiver may hypothesize that a packet has double bit errors occurring at non-consecutive bit error positions by flipping two bits, both of which are selected from the candidate bit error positions identified using the softbit metric. For example, when there are N candidate bit error positions identified, the receiver may flip two bits corresponding two candidate error positions to generate N(N−1)/2 candidate error-free packets, each candidate error-free packet flipping two bits at a different pair of bit positions. The receiver may run the CRC on the N candidate error-free packets to determine if any pair corrects the double bit error in the originally demodulated packet.

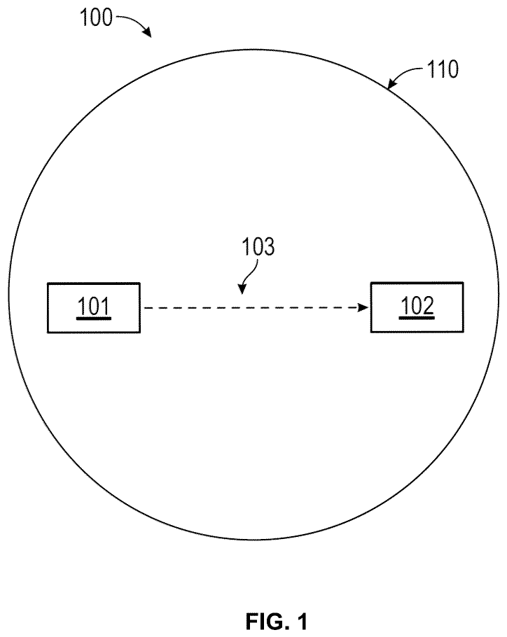

FIG. 1 illustrates an example network architecture 100, in accordance with some embodiments of the present disclosure. As shown in FIG. 1, the network architecture 100 may include a transmitter 101 and a receiver 102. The transmitter 101 may transmit wireless radio-frequency signals carrying data packets (or data messages, frames, etc.) to the receiver 102, as indicated by arrow 103. The receiver 102 may receive the transmitted signals to extract the data packets. If the receiver 102 detects that a transmitted data packet is correctly received without bit errors, the receiver 102 may send a notification such as an acknowledgement (ACK) to the transmitter 101. The transmitter 101 will not retransmit the correctly received data packet. On the other hand, if the receiver 102 detects that a received data packet is a corrupted data packet including one or more bit errors, the receiver 102 may send a notification such as a negative acknowledgement (NACK) to the transmitter 101. The transmitter 101 will retransmit the data packet to the receiver 102. The circle 110 illustrated in FIG. 1 may represent the range of the radio-frequency signals transmitted by the transmitter 101. Receivers such as the receiver 102 that are located within the circle 110 may be able to receive radio-frequency signals transmitted by the transmitter 101.

In one embodiment, the network architecture 100 may be a Bluetooth® network. A Bluetooth® network may be a wireless network that includes network devices which communicate using radio frequencies, protocols, standards, data formats, etc., that have been defined by the Bluetooth® Special Interest Group (Bluetooth® SIG). In this embodiment, the transmitter 101 may be a Bluetooth® transmitter and the receiver 102 may be a Bluetooth® receiver. The data packets transmitted from the transmitter 101 to the receiver 102 may be Bluetooth® packets. In some embodiments, the Bluetooth® network (e.g., the devices within the Bluetooth® network) may use the Bluetooth® Low Energy (BLE) standard. The network architecture 100 may also include other nodes, components and/or devices not shown in FIG. 1.

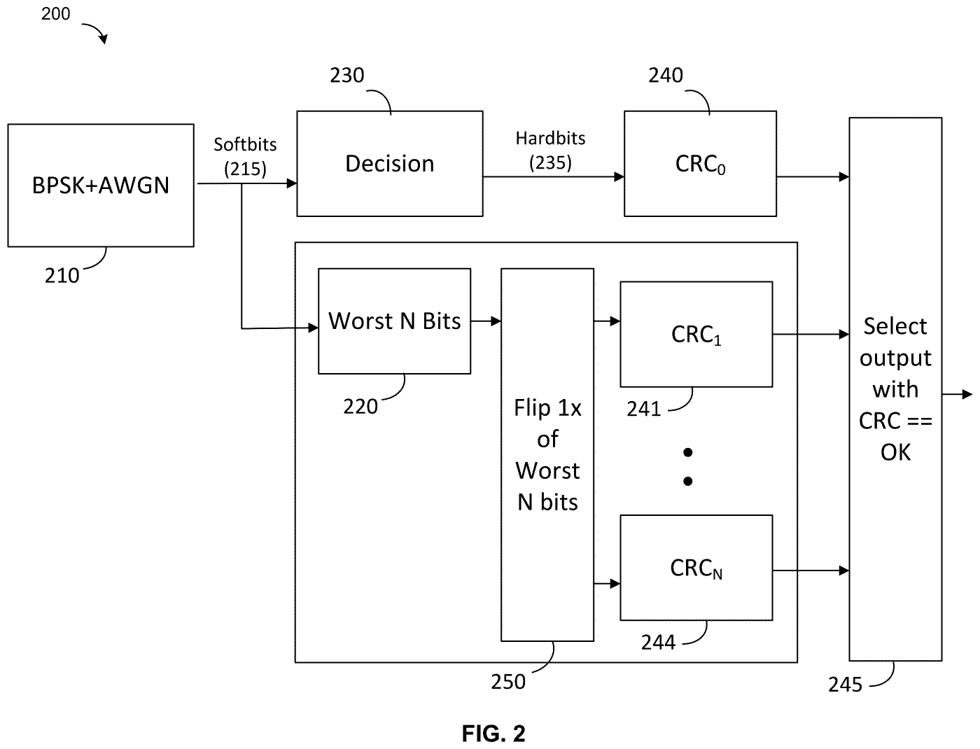

FIG. 2 illustrates a block diagram of a receiver 200 to flip demodulated bits to correct bit errors based on hypothesized bit error positions within a packet, in accordance with some embodiments of the present disclosure.

The received signal may be a binary phase shift keying (BPSK) modulated signal that has been corrupted by additive white Gaussian noise (AWGN). A BPSK demodulator 210 may generate softbits 215 for each bit of a packet. Softbits 215 for a bit may be a metric that indicates the probability of a demodulated bit error. In one embodiment, softbits 215 may represent the distance of a received bit from a bit decision threshold. The bigger the distance a received bit corrupted by noise is from the bit decision threshold, the lower the probability that the bit decision makes a bit error. In one embodiment, softbits 215 may represent a quantitative difference between the hypotheses that a received bit is a 1 and the hypothesis that the bit is a 0. The bigger the difference between the two hypotheses for a bit, the lower the probability that the bit decision makes a bit error. Conversely, the smaller the distance from the bit decision threshold or the smaller the difference between the two hypotheses for a received bit, the higher the probability that the bit decision makes a bit error.

A decision module 230 may make bit decisions based on softbits 215 for each bit of the packet. For BPSK demodulation, decision module 230 may compare softbits 215 to a decision threshold of 0 to generate hardbits 235. If softbit 215 for a bit is positive, decision module 230 may generate hardbit 235 of 0 for the bit; if softbit 215 for a bit is negative, decision module 230 may generate hardbit 235 of 1 for the bit.

A softbit module 220 may receive softbits 215 for each bit of a packet to identify the N worst softbits. The N worst softbits may represent the bit positions with the N highest probability of bit errors in the packet. For BPSK demodulation, the N worst softbits may be softbits 215 with their absolute values closest to the decision threshold of 0. The hardbits 235 corresponding to the N worst softbits may be hypothesized to have the highest probability of bit errors due to the close distance of the corresponding softbits 215 from the decision threshold.

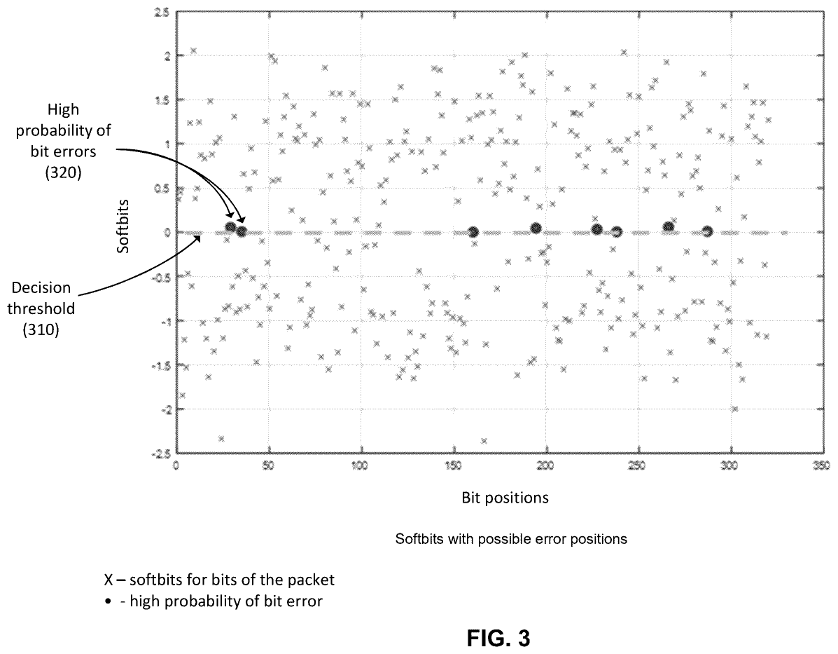

FIG. 3 illustrates a plot of bit positions in a packet hypothesized to have a high probability of bit errors based on a softbit metric for a BPSK modulated signal in accordance with some embodiments of the present disclosure.

The softbits for the bits of the packet exhibit a distribution of distances from the decision threshold 310, which is 0 for BPSK. The N softbits closest to the decision threshold 310 identifies the bit positions of the N demodulated bits with the highest probability of bit errors. For N=8, FIG. 3 shows the bit positions P(i), i=1 . . . 8 (320) of the 8 most likely wrong bits. In one embodiment, N may be configurable. For example, N may be 1 when demodulation latency is critical. In applications where demodulation latency is less of a concern, N may be larger. In one embodiment, N may be a function of the length of the packet.

Returning to FIG. 2, a CRC₀ module 240 may run the CRC on hardbits 235 of the packet. If the CRC passes, the packet has no error bits. If the CRC fails, an error correction module 250 may flip one or more hardbits 235 of the packet based on the bit positions of the N worst softbits identified by softbit module 220. In one embodiment, the packet is hypothesized to have a single bit error. To correct the single bit error, error correction module 250 may flip one hardbit 235 of the packet at each of the N bit positions P(i), i=1 . . . N identified to have the highest probability of bit errors based on the N worst softbits 215, yielding N candidate error-free packets.

Additional CRC modules CRC₁ (241) . . . CRC_{N} (245) may run the CRC on the N candidate error-free packets to determine if any one of the N bit positions identified to have the highest probability of bit errors correctly identifies the bit error position of the packet. If a candidate error-free packet m passes the CRC, error correction module 250 has successfully corrected the single bit error in the packet at position P(m). A candidate packet selection module 245 may select the candidate packet that passes the CRC as an error-free packet for further processing by higher layers. If none of the N candidate error-free packets passes the CRC, error correction module 250 may flip hardbits 235 of the packet based on a different strategy or request re-transmission of the packet.

In one embodiment, the last bit and/or the first bit of the packet may have a higher probability to produce bit errors than the remaining bits of the packet. In addition to flipping the single bit errors at each of the N bit positions P(i), i=1 . . . N identified to have the highest probability of bit errors, additional CRC checks may be based on flipping the first bit, the last bit, or both of the packet. In one embodiment, the decision to additionally flip such bits may be based on the error statistics of the packet.

In one embodiment, the packet is hypothesized to have double bit errors at consecutive bit positions (also referred to as paired bit errors) for a demodulator with a decision feedback architecture. To correct the paired bit errors, error correction module 250 may flip two consecutive hardbits 235 of the packet starting at each of the N bit positions P(i), i=1 . . . N identified to have the highest probability of bit errors based on the N worst softbits 215. There will again be N candidate error-free packets to check to determine if any one candidate error-free packet passes the CRC. Each candidate error-free packet flips hardbits 235 at one of the N bit positions P(i) and the immediately following bit position P(i)+1. If a candidate error-free packet m passes the CRC, error correction module 250 has successfully corrected the paired bit errors in the packet at position P(m) and P(m)+1.

In one embodiment, to correct the paired bit errors, error correction module 250 may flip two consecutive hardbits 235 of the packet starting at bit positions P(i)+/−p bit, where p denotes the size of the window for flipping two consecutive hardbits 235 around P(i), i=1 . . . N. For example, the flipped bit positions may be at [P(i)−p, P(i)−p+1], [P(i)−p+1, P(i)−p+2] . . . [P(i)+p−1, P(i)−p]. In one embodiment, p may be configurable. In one embodiment, error correction module 250 may correct hypothesized paired bit errors first based on P(i), i=1 . . . N first. If none of the candidate error-free packets with a flipped pair of hardbits 235 passes the CRC, error correction module 250 may correct hypothesized single bit errors based on P(i), i=1 . . . N to determine if any of the candidate error-free packets with a single flipped hardbit 235 passes the CRC.

In one embodiment, the packet is hypothesized to have double bit errors that are allowed to be at non-consecutive bit positions. To correct the double bit errors, error correction module 250 may flip two hardbits 235 of the packet at bit positions P(i) and P(j), i=1 . . . N, j=1 . . . N, i≠j, selected from the N bit positions identified to have the highest probability of bit errors based on the N worst softbits 215. There may be N(N−1)/2 candidate error-free packets to check for the CRC. If a candidate error-free packet passes the CRC, error correction module 250 has successfully corrected the double bit errors in the packet at the corresponding two bit positions selected from P(i) and P(j).

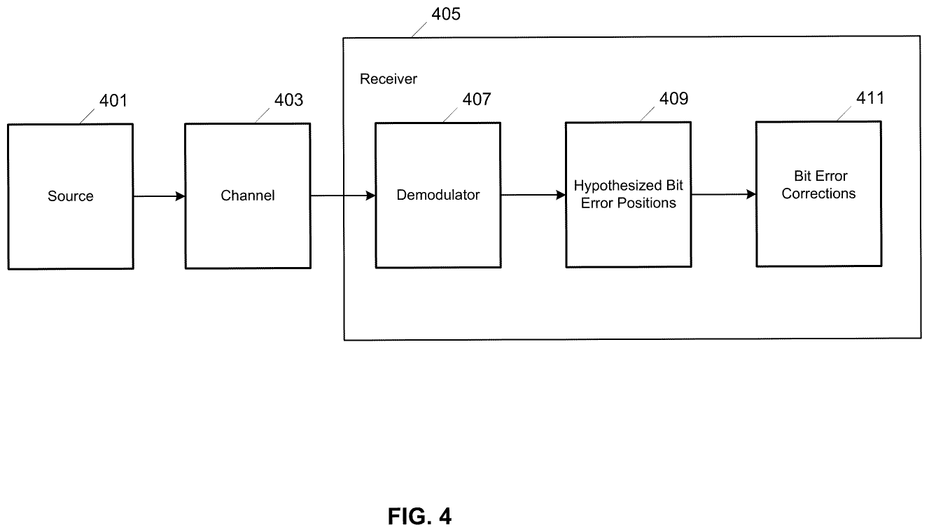

FIG. 4 illustrates a processing model of a packet from a data source 401 to a receiver 405 that attempts to correct bit errors in the demodulated packet based on hypothesized bit error positions, in accordance with some embodiments of the present disclosure.

Data source 401 may transmit packets of modulated data through a channel 403. For example, data source 401 may be a BLE transmitter (e.g., transmitter 101 of FIG. 1) transmitting data or control packets using BLE protocol. The channel 403 may be an AWGN channel that introduces random bit errors when the modulated bits of the packets are demodulated.

Demodulator 407 may demodulate the received bits of the packets to generate softbits as described. The softbits may be used as metrics to indicate the probability of a demodulated bit error for each bit of the packets due to channel impairments. Demodulator 407 may generate hard decisions (e.g., hardbits) for the bits based on the softbits such as by comparing the softbits for each bit to a decision threshold. In case of packet errors, such as when the CRC of the packet fails, a hypothesized bit error positions module 409 may process the softbits to identify one or more hardbits and their corresponding bit position(s) in the packet with the highest probability of bit errors. The bits position(s) with the highest probability of bit errors represent hypothesized or candidate bit position(s) of erroneously demodulated bit(s). By flipping one or more of the hardbits based on the hypothesized bit error position(s) to generate one or more hypothesized or candidate error-free packet(s) and running CRC to ascertain if one candidate packet is indeed error-free, a bit error correction module 411 may attempt to correct for the bit errors without requesting for a retransmission of error packets.

Bit error corrections 411 may employ a variety of bit flipping strategies based on the type of demodulator 407, the length of the packet, the signal modulation scheme, characteristics of the channel, maximum demodulation latency, error statistics, etc. For example, when demodulator 407 has a decision feedback architecture, bit errors tend to occur in pairs (e.g., two consecutive bit positions). In this case, bit error correction module 411 may flip two consecutive hardbits per candidate packet in which the bit position for one of the paired hardbits is selected from the hypothesized bit error position(s). The number of candidate packets of different paired flipped bit positions may be configurable. When none of the candidate packets with paired flipped bits passes the CRC, bit error correction module 411 may flip a single hardbit per candidate packet based on the hypothesized bit error position(s). Again, the number of candidate packets of different single flipped bits for the CRC check may be configurable.

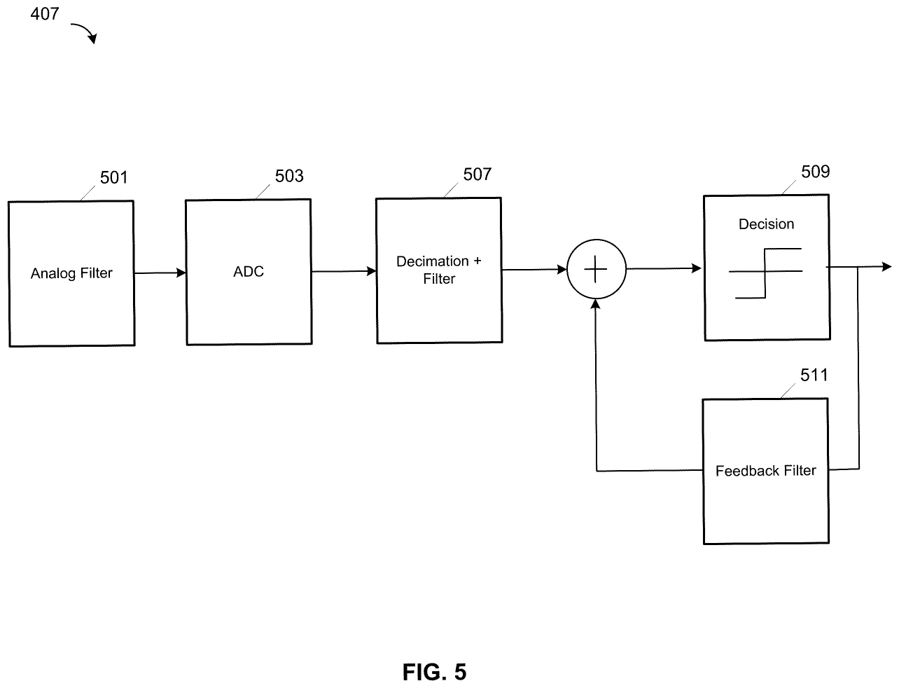

FIG. 5 illustrates a block diagram of a demodulator 407 with a decision feedback equalizer that has a high probability of producing consecutive bit errors correctable by flipping two consecutive bits based on hypothesized bit error positions, in accordance with some embodiments of the present disclosure.

In BLE, Gaussian frequency shift keying (GFSK) modulation is used where the data bits are convolved with a rectangular signal and then with a Gaussian pulse before being used to frequency modulate a carrier. The advantage of GFSK modulation is that the envelope of the modulated waveform is constant, allowing the use of low cost linear power amplifier. The modulated waveform is also continuous in phase at the edges of symbols, reducing out-of-band spectral sidelobes and allowing for more channels in a given bandwidth.

A decision feedback equalizer may be used to demodulate GFSK modulated signal to improve receiver sensitivity. An analog filter 501 such as a frequency discriminator followed by a low pass filter may process the GFSK modulated signal down to baseband. An analog digital converter (ADC) 503 may oversample the baseband signal to provide digitized samples to a decision feedback equalizer that includes a feedforward filter 507 and a feedback filter 511. A bit decision 509 is made for each bit by comparing to a variable threshold that depends on the previous detected bit. Due to the decision feedback, an error in the bit decision 509 may trigger a second error on the next demodulated bit so that bit errors tend to occur in pairs. In addition to the hardbits, the decision feedback equalizer may generate softbits to indicate the probability of a bit error corresponding to the hardbits.

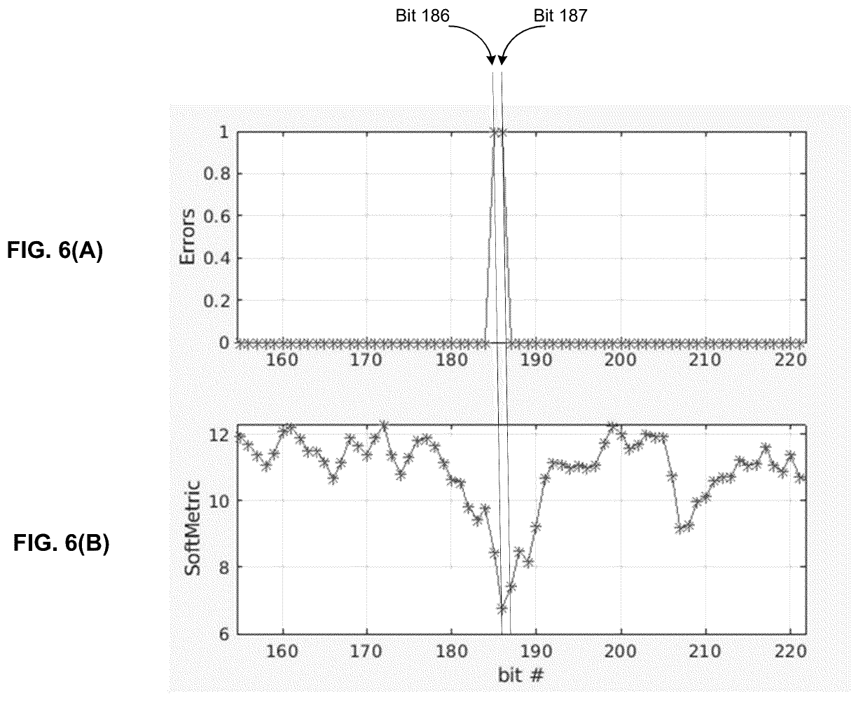

FIG. 6(A) illustrates a plot of bit positions for a pair of bit errors in a packet of demodulated bits produced by a demodulator with a decision feedback equalizer, in accordance with some embodiments of the present disclosure. The pair of bit errors occurs at bit position 186 and 187 of the packet.

FIG. 6(B) illustrates the softbit metric corresponding to the demodulated bits of the packet of FIG. 6(A) produced by the demodulator with a decision feedback equalizer, in accordance with some embodiments of the present disclosure. The softbit metric is at the minimum at bit position 186. By flipping two consecutive demodulated bits based on the bit position indicated by the minimum softbit metric, the decision feedback equalizer may correct the pair of bit errors in the packet.

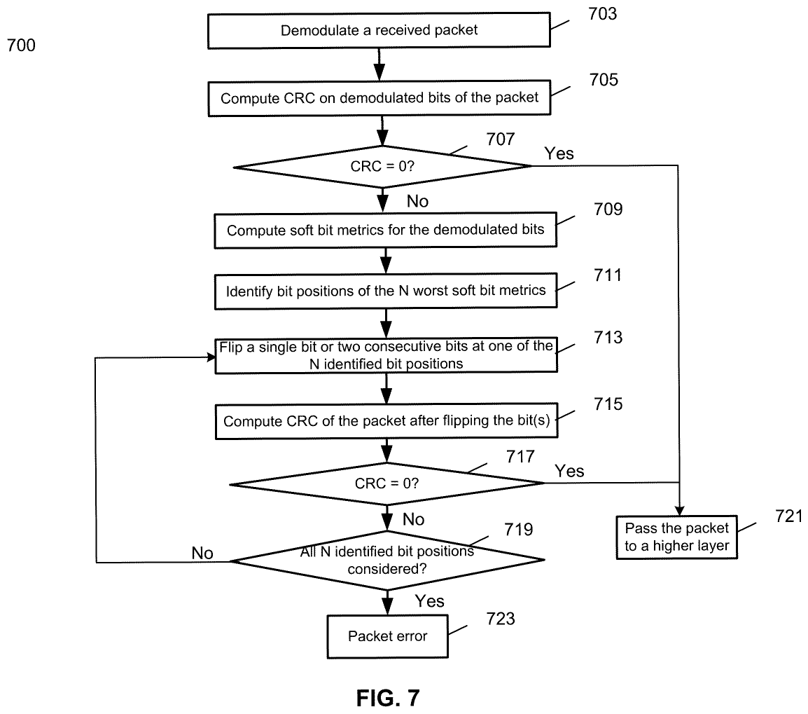

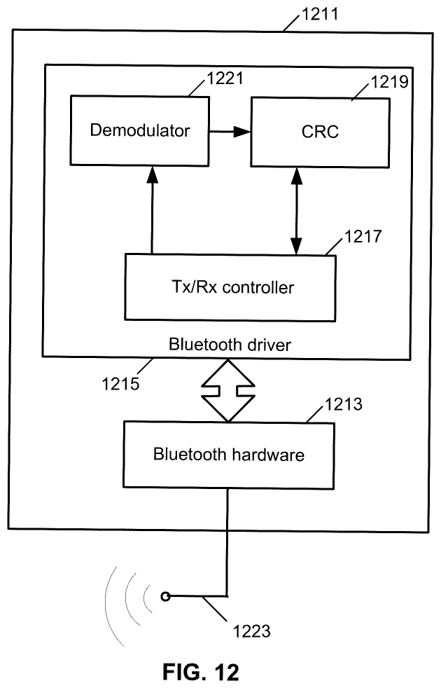

FIG. 7 illustrates a flow diagram of a method 700 to correct single or two consecutive bit errors in the demodulated bits of a packet based on hypothesized bit error positions, in accordance with some embodiments of the present disclosure. Method 700 may be performed by processing logic that may include hardware (e.g., circuitry, dedicated logic, programmable logic, a processor, a processing device, a central processing unit (CPU), a multi-core processor, a system-on-chip (SoC), etc.), software (e.g., instructions running/executing on a processing device), firmware (e.g., microcode), or a combination thereof. In some embodiments, method 700 may be performed by the receiver 200 of FIG. 2, receiver 405 of FIG. 4, or a processing device included in the receiver 102 (e.g., processing device 1211 illustrated in FIG. 12)

In operation 703, method 700 demodulates bits of a received packet. The packet may include a header, payload, and a CRC checksum. The bits of the packet may be corrupted by noise, causing some of the demodulated bits to be different from the source bits in the transmitted packet.

In operation 705, method 700 computes the CRC on the demodulated bits of the packet to determine if the packet is error free. If the computed CRC checksum matches the received CRC checksum of the packet, the received packet was received without any errors. Otherwise, if the computed CRC checksum does not match the received CRC checksum, the packet was corrupted. In one aspect, method 700 may compute the CRC checksum, also referred to as error syndrome, on the packet including the received CRC checksum. If the computed CRC checksum is zero, the received packet including the received CRC checksum has no errors. Otherwise, the packet has errors.

In operation 707, method 700 checks if the computed CRC checksum is zero. If it is, in operation 721, method 700 passes the error-free packet to a higher layer for further processing.

If the CRC checksum is not zero, in operation 709, method 700 computes softbit metrics for the demodulated bits. In one embodiment, softbit metrics may have been computed in operation 703 for use in generating the demodulated bits of the packet. In one embodiment, softbit metrics may represent the distance of a received bit in the demodulation space from a bit decision threshold. In one embodiment, softbit metrics may represent a difference between the likelihood of 0 and 1 hypotheses for a received bit. The softbit metrics may be computed for each received bit of the packet to indicate the probability of a bit error for the corresponding demodulated bit.

In operation 711, method 700 identifies one or more bit positions of the packet with the worst softbit metrics. In one embodiment, the number of bit positions identified may be N, where N is configurable. The N worst softbits may identify the N bit positions with the highest probability of bit errors in the demodulated packet. In one embodiment, operation 711 may sort the N bit positions in a descending order of the associated softbit metrics starting from the bit position associated with the worst softbit metrics of the packet.

In operation 713, method 700 flips a single bit or two consecutive bits at one of the N bit positions. In one embodiment, bit errors tend to occur in pairs, such as in a demodulator with a decision feedback architecture. Operation 713 may flip two consecutive demodulated bits of the packet starting at one of the N bit positions. In one embodiment, if the N bit positions are sorted as described in operation 711, operation 713 may flip two consecutive bits starting at the bit position associated with the worst softbit metrics of the packet to generate a candidate packet. In one embodiment, operation 713 may flip two non-consecutive bits selected from two of the N bit positions.

In operation 715, method 700 computes the CRC of the candidate packet with the flipped bit(s). If the computed CRC checksum of the candidate packet is zero, the bit position(s) of the flipped bit(s) in the candidate packet correctly identifies the bit position(s) of the error bit(s) in the originally demodulated packet.

In operation 717, method 700 checks if the computed CRC checksum of the candidate packet is zero. If it is, method 700 passes the candidate packet that is error-free to a higher layer for further processing in operation 721.

If the computed CRC checksum of the candidate packet is not zero, in operation 719, method 700 determines if all N bit positions with the highest probability of bit errors have had their corresponding demodulated bits flipped. If not, method 700 returns to operation 713 to flip a single bit or two consecutive bits at the next N bit position whose corresponding bits have not been flipped. In one embodiment, if the N bit positions are sorted, operation 713 may flip a single bit at, or two consecutive bits starting at, the bit position associated with the next worst softbit metrics of the packet to generate the next candidate packet. Method 700 repeats operations 715 and 717 to check if the next candidate packet corrects the bit error(s) in the originally demodulated packet. In one embodiment, operation 713 may generate N candidate packets with a pair of flipped bits starting from the bit positions associated with the worst softbit metrics in a descending order of probabilities of bit errors. If none of the N candidate packets with a pair of flipped bits passes the CRC in operations 715 and 717, operation 713 may generate N additional candidate packets with a single flipped bit starting from the bit positions associated with the worst softbit metrics in a descending order of probabilities of bit errors to determine if any of the N additional candidate packets passes the CRC.

In operation 723, if N bit positions with the highest probability of bit errors have had their corresponding demodulated bits flipped to generate candidate packets and none of the candidate packets corrects the bit error(s) in the originally demodulated packet, method 700 declares a packet error and may request retransmission of the packet.

Computations of CRC checksum of the candidate packets may be a trade-off between complexity and speed. A single CRC processing unit may sequentially perform CRC checksum for each of the candidate packets. However, if the number of candidate packets is large, computational latency may be unacceptable. On the other hand, parallel checksum computations of the candidate packets reduce CRC latency but at a cost of increased hardware complexity. One approach to computing CRC checksum may be to use a look up table to strike a balance between complexity and performance.

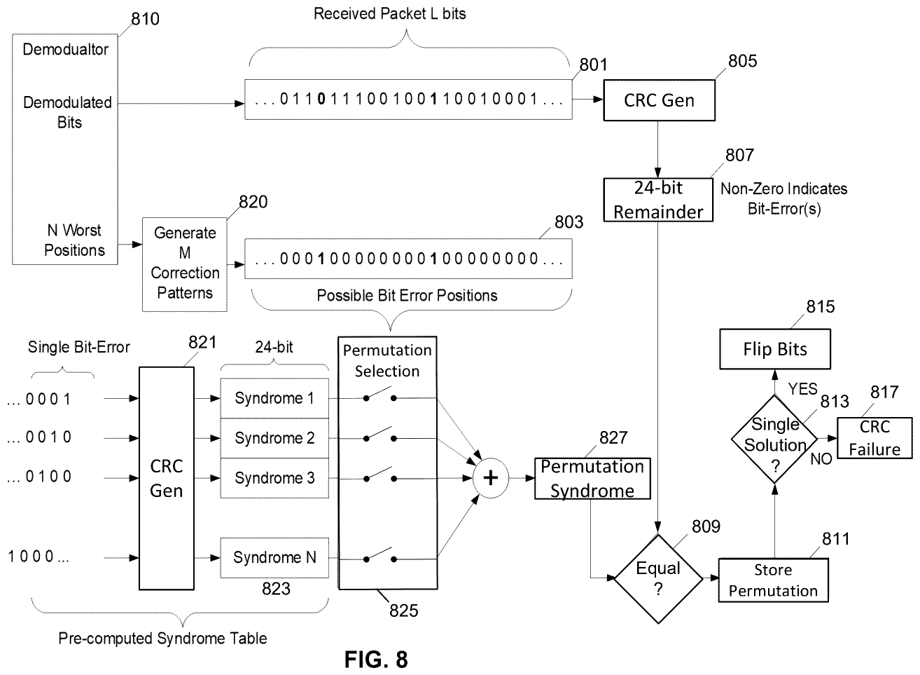

FIG. 8 illustrates a block diagram of a technique to identify bit error positions based on a comparison of CRC of a demodulated packet and permutations of CRC derived from precomputed syndromes for a 1-bit error in different bit positions within a packet, in accordance with some embodiments of the present disclosure.

A CRC generation module 805 may compute the CRC checksum of a received packet 801 from a demodulator 810. In BLE, the CRC checksum may be three bytes. If the CRC checksum is non-zero, the received packet 801 has at least one bit error and the CRC checksum may be stored as a 24-bit CRC remainder 807. In one embodiment, CRC generation module 805 may compute the CRC checksum while receiving the demodulated bits from demodulator 810 (on-line). In another embodiment, CRC generation module 805 may compute the CRC checksum after all the bits of the packet have been demodulated and stored in a memory.

Demodulator 810 may identify the bit positions of N bits in the packet with the highest probability of bit errors (N highest risk bits) based on softbit metrics. A bit flipping module 820 may generate M correction patterns 803 based on the bit positions of the N risk bits. For example, each of the M correction patterns 803 may contain hypothesized bit error positions based on the N highest risk bits. The CRC-based error correction technique may check if the CRC checksum of any of the M correction patterns 803 matches the CRC remainder 807 of the received packet 801. In one embodiment, the number of hypothesized bit errors in each of the M correction patterns 803 is limited to 2 or 1, as discussed for the candidate packets with two flipped bits or a single flipped bit. Once the hypothesized bit error positions are identified, the corresponding pre-computed single-bit error syndromes are extracted.

For BLE, the total maximum bytes covered by the CRC including the CRC itself is 260 bytes or 2080 bits. To perform CRC-based error correction, the CRC syndrome 823 for each individual bit is required, which for the 3-byte CRC requires a 6240-byte table. The table required for packets that are less than the maximum length is a subset of the maximum table. Hence, this maximum table is all that is required to support all possible packet sizes. The CRC syndrome table 823 for all 2080 single-bit errors may be precomputed by a CRC syndrome generation unit 821. The CRC-based error correction technique may use the hypothesized bit-error positions of each of the M correction patterns 803 to address the syndrome table 823 to extract the corresponding single-bit error syndromes. In one embodiment, the single-bit error syndromes may be selected by selection block 825 based on the hypothesized bit-error positions of a correction pattern 803. For example, for a correction pattern 803 with two hypothesized bit-error positions, the single-bit error syndromes for the two hypothesized bit-errors selected from the syndrome table 823 may be XOR'ed to generate the permutation syndrome 827.

At block 809, if the permutation syndrome 827 matches the non-zero CRC remainder 807 of the original packet, the corresponding hypothesized bit-error positions may be stored at block 811 to reconstruct an error-free payload. Otherwise, if there is no match, the CRC-based error correction technique may extract the error syndrome for the next one of the M correction patterns 803 based its hypothesized bit error positions. At block 813, after computing the permutation syndromes 827 for all M correction patterns 803, the CRC-based error correction technique may verify if a match is found for only a single correction pattern. If this condition is true, at block 815, the bits in the received packet 801 corresponding to the hypothesized bit-error positions of the matching correction pattern are flipped to reconstruct an error-free packet. Otherwise, if there is no single correction pattern is found, the CRC-based error correction technique fails to correct the bit errors and CRC failure is declared at block 817.

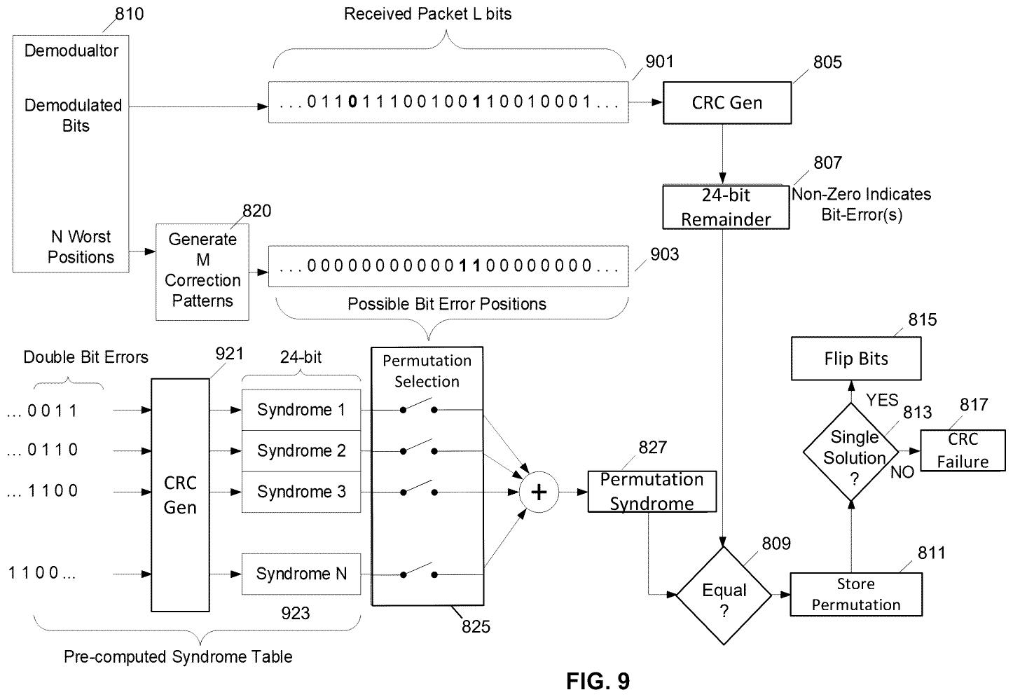

FIGS. 9 illustrate a block diagram of a technique to identify bit error positions based a comparison of CRC of a demodulated packet and permutations of CRC derived from precomputed syndromes for two consecutive bit errors in different bit positions within a packet, in accordance with some embodiments of the present disclosure.

In FIG. 9, demodulator 810 may generate a pair of consecutive bit errors for the received packet 901, such as when using a demodulator with a decision feedback architecture. Bit flipping module 820 may generate M correction patterns 903 containing two consecutive hypothesized bit error positions based on the N highest risk bits. The CRC-based error correction technique may again check if the CRC checksum of any of the M correction patterns 903 matches the CRC remainder 807 of the received packet 901.

In the case of hypothesized consecutive bit errors, a CRC syndrome generation unit 921 may precompute the CRC syndrome table 923 for two consecutive bits for all possible paired bit positions by shifting a pair of 1's across the maximum 2080 bits of a BLE packet. The size of the CRC syndrome table 923 may be the same as the CRC syndrome table 823 for the single-bit errors of FIG. 8. The two consecutive hypothesized bit error positions of each of the M correction patterns 903 may address the CRC syndrome table 923 to extract the corresponding paired-bit error syndromes. The operation of the CRC-based error correction technique for the paired-bit error syndromes may be similar to that for the single-bit error syndromes of FIG. 8 and will not be repeated for brevity.

Comparing the CRC-based error correction techniques of FIG. 8 and FIG. 9, the single-bit error syndromes of FIG. 8 is more flexible because it allows for different permutations of bit errors (e.g., two consecutive bit error, two non-consecutive bit errors, or a single-bit error in a packet). However, knowing that bit errors have a high probability of occurring in two consecutive bits may allow a CRC-based error correction technique to identify the positions of the two consecutive error bits in a packet without the knowledge of the most likely error bit positions given by the worst softbit metric.

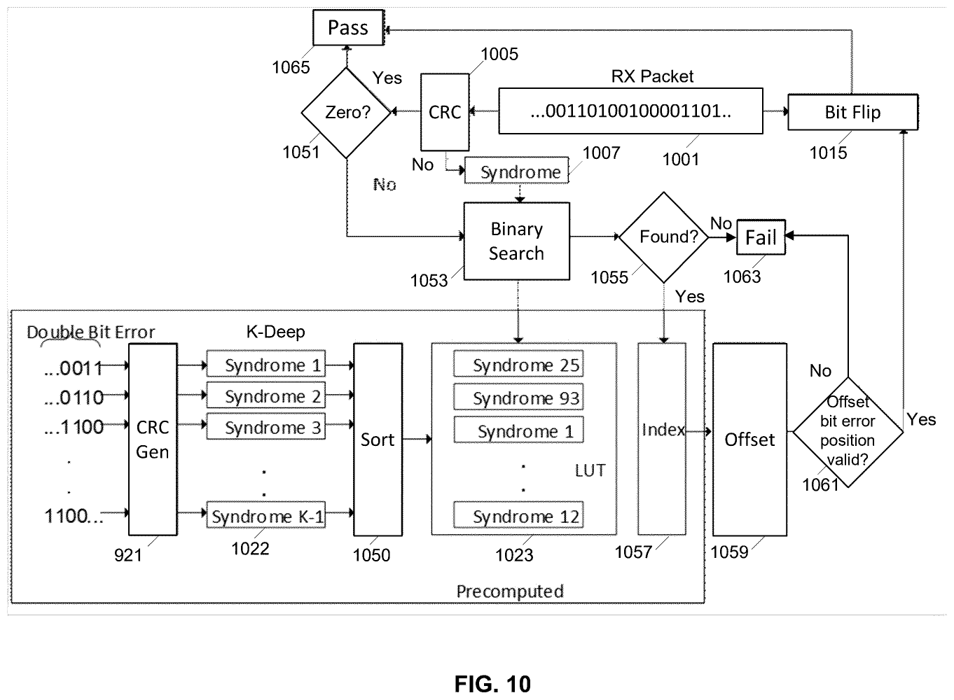

FIGS. 10 illustrates a block diagram of a technique to identify bit error positions based a comparison of CRC of a demodulated packet and an exhaustive search of CRC derived from precomputed syndromes for two consecutive bit errors in different bit positions within a packet, in accordance with some embodiments of the present disclosure.

Similar to FIG. 9, in the case of hypothesized consecutive bit errors, a CRC syndrome generation unit 921 may precompute the CRC syndromes 1022 for two consecutive bits for all possible paired bit positions by shifting a pair of 1's across the maximum K-bit length of a packet (e.g., 2080 bits of a BLE packet). However, different from FIG. 9, the precomputed syndromes 1022 are sorted by block 1050 in ascending order. A CRC syndrome look up table (LUT) 1023 may store the sorted precomputed syndromes along with information on the corresponding bit positions of the two 1's.

A CRC generation module 1005 may compute the CRC checksum of a received packet 1001 from a demodulator (not shown). The CRC checksum is checked against zero at block 1051. If the CRC checksum is zero, the packet is received successfully at block 1065. Otherwise, the CRC fails and the CRC checksum may be stored as a packet syndrome 1007. Block 1053 may conduct a binary search of the packet syndrome 1007 in the CRC syndrome LUT 1023 since the precomputed CRC syndromes are sorted. At block 1055, the CRC-based error correction technique may verify if the packet syndrome 1007 is found in the CRC syndrome LUT 1023. If the packet syndrome 1007 cannot be found in the CRC syndrome LUT 1023, the packet has a different error pattern and cannot be corrected by the CRC-based error correction technique of FIG. 10. Block 1063 declares an error packet.

Otherwise, if the packet syndrome 1007 can be found in the CRC syndrome LUT 1023, the corresponding bit positions of the two 1's indicate the bit positions of the consecutive errors. The consecutive bit error positions are read from the CRC syndrome LUT 1023 and stored in a position index 1057. After offsetting the consecutive bit error positions according to the actual packet length in block 1059, where the actual packet length may be shorted than the K bits used for the generation of the CRC syndrome LUT 1023, block 1061 determines if the offset bit-error positions are valid. If they are valid, block 1015 flips two consecutive bits in the received packet 1001 corresponding to the offset bit-error positions to reconstruct an error-free packet. Otherwise, block 1063 declares an error packet. The exhaustive search of packet syndrome 1007 against all possible consecutive bit-error syndromes of a packet in FIG. 10 is a special case of the CRC-based error correction technique of FIG. 9 where N (the number of high risk bits)=K (maximum bit length of a packet)−1, and M (number of correction patterns)=N.

Every CRC code has defined a minimum hamming distance D. It means that in case the number of errors is equal or larger than D, the CRC check can pass although there are errors in the packet. This condition is called “undetected errors (UE).” Assuming a received packet has D−1 errors, flipping a correct bit might lead to a UE condition and a wrong packet might be passed as correct to higher levels. For data integrity this condition should be avoided or at least kept to an acceptable level. To trigger the UE condition, the packet may already contain multiple bit errors so that with the additional bit flips in the CRC-based error correction technique, the number of errors may exceed the hamming distance.

To avoid the UE condition, in one embodiment, the exhaustive search technique of FIG. 10 may be suspended when the received packet is presumed or identified to contain multiple bit errors. In one embodiment, a decision criterion to suspend the exhaustive search technique may use a SNR metric. For example, the demodulator may provide a metric indicating the measured SNR for the packet. The demodulator may decide if it is safe to execute the exhaustive search technique by comparing the measured SNR with a SNR threshold associated with a number of bit errors that is close to the hamming distance. If the measured SNR does not exceed the SNR threshold, the demodulator may suspend the exhaustive search technique. Other metrics may be used such as ones based on the received signal strength indicator (RSSI), the average softbit metric for the packet, the number of softbit metric events worst than a threshold, etc.

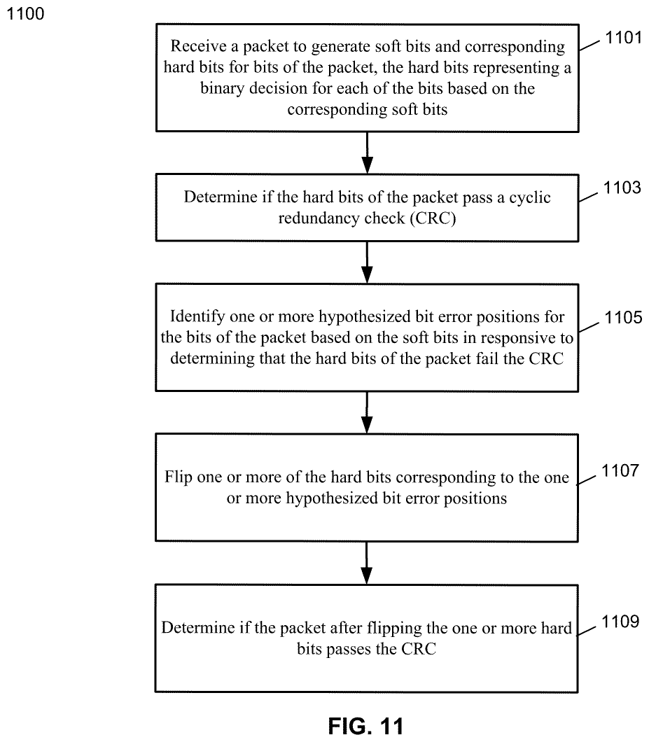

FIG. 11 illustrates a flow diagram of a method 1100 to correct one or more bit errors in the demodulated bits of a packet based on hypothesized bit error positions derived from softbit metrics for the bits, in accordance with some embodiments of the present disclosure. Method 1100 may be performed by processing logic that may include hardware (e.g., circuitry, dedicated logic, programmable logic, a processor, a processing device, a central processing unit (CPU), a multi-core processor, a system-on-chip (SoC), etc.), software (e.g., instructions running/executing on a processing device), firmware (e.g., microcode), or a combination thereof. In some embodiments, method 1100 may be performed by the receiver 200 of FIG. 2, receiver 405 of FIG. 4, or a processing device included in the receiver 102 (e.g., processing device 1211 illustrated in FIG. 12).

In operation 1101, method 1100 receives a packet to generate soft bits and corresponding hard bits for bits of the packet. The hard bits represent a binary decision for each of the bits based on the corresponding soft bits.

In operation 1103, method 1100 determines if the hard bits of the packet pass a CRC.

In operation 1105, method 1100 identifies one or more hypothesized bit error positions for the bits of the packet based on the soft bits in responsive to determining that the hard bits of the packet fail the CRC.

In operation 1107, method 1100 flips one or more of the hard bits corresponding to the one or more hypothesized bit error positions.

In operation 1109, method 1100 determines if the packet after flipping the one or more hard bits passes the CRC.

FIG. 12 is a block diagram of a Bluetooth device 1211 showing hardware and software drivers with CRC processing assisted by a softbit metric of the demodulator to correct bit errors within a packet, in accordance with some embodiments of the present disclosure. The Bluetooth device 1211 may be the receiver 200 or 405 and may practice the operations of methods 7 and 11.

The Bluetooth device 1211 may include one or more antennas 1223, Bluetooth hardware 1213 and Bluetooth driver 1215. The Bluetooth driver 1215 may include Bluetooth Tx/RX controller 1217, demodulator 1221, and CRC-based error correction logic 1219. The Bluetooth hardware 1213 may be configured to transmit or receive BLE packets on an operating channel through the antennas 1223.

The Bluetooth Tx/Rx controller 1217 may be configured to demodulate and decode received BLE packets and to encode and modulate BLE packets for transmission. The demodulator 1221 may be configured to generate the softbit metric for each bit of a packet to identify candidate bit positions for demodulated bits that have a high probability of a wrong bit decision. When a demodulated packet fails the CRC, the CRC-based error correction logic 1219 may be configured to flip one or more bits of the demodulated packet corresponding to the candidate bit positions to correct bit errors in the corrupted BLE packets.

In one embodiment, the Bluetooth device 1211 may include a memory and a processing device. The memory may be synchronous dynamic random access memory (DRAM), read-only memory (ROM)), or other types of memory, which may be configured to store the code to perform the function of the Bluetooth driver 1215. The processing device may be provided by one or more general-purpose processing devices such as a microprocessor, central processing unit, or the like. In an illustrative example, processing device may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device may also comprise one or more special-purpose processing devices such as an application specific integrated circuit (ASIC), a field programmable gate array (FPGA), a digital signal processor (DSP), network processor, or the like. The processing device may be configured to execute the operations described herein, in accordance with one or more aspects of the present disclosure, for performing the operations and steps discussed herein.

Unless specifically stated otherwise, terms such as “receiving,” “generating,” “verifying,” “performing,” “correcting,” “identifying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

Certain embodiments may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions. The machine-readable medium may be referred to as a non-transitory machine-readable medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. For example, while aspects of the subject technology are described in the context of BLE, it is understood that the subject technology is applicable to other wireless networks running packet based protocol including but not limited to cellular networks (e.g., Long-Term Evolution (LTE) networks), wireless local area networks (WLANs), wireless sensor networks and satellite communication networks,. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Also, the terms “first,” “second,” “third,” “fourth,” etc., as used herein are meant as labels to distinguish among different elements and may not necessarily have an ordinal meaning according to their numerical designation. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
receiving a packet to generate soft bits and corresponding hard bits for bits of the packet, the hard bits representing a binary decision for each of the bits based on the corresponding soft bits;
determining if the hard bits of the packet pass a cyclic redundancy check (CRC);
identifying one or more hypothesized bit error positions for the bits of the packet based on the soft bits in responsive to determining that the hard bits of the packet fail the CRC;
flipping one or more of the hard bits corresponding to the one or more hypothesized bit error positions; and
determining if the packet after flipping the one or more hard bits passes the CRC.

2. The method of claim 1, wherein the soft bits represent metrics to indicate a probability of a wrong decision for a corresponding one of the hard bits and wherein the hypothesized bit error positions indicate the hard bits representing one or more highest probabilities of a wrong binary decision in the packet.

3. The method of claim 2, wherein flipping the one or more hard bits comprises:
flipping a first bit of the hard bits indicated by the hypothesized bit error positions as representing a highest probability of a wrong binary decision; and
flipping a second bit of the hard bits immediately following the first bit.

4. The method of claim 3, wherein determining if the packet after flipping the one or more hard bits passes the CRC comprises:
determining that the packet after flipping the first bit and the second bit still fails to pass the CRC;
un-flipping the first bit and the second bit back to their binary decisions as originally generated;
flipping a third bit of the hard bits indicated by the hypothesized bit error positions as representing a second highest probability of a wrong binary decision; and
flipping a fourth bit of the hard bits immediately following the third bit.

5. The method of claim 3, wherein determining if the packet after flipping the one or more hard bits passes the CRC comprises:
determining that the packet after flipping the first bit and the second bit still fails to pass the CRC;
un-flipping the second bit of the hard bits back to its binary decision as originally generated; and
determining if the packet after flipping only the first bit of the hard bits passes the CRC.

6. The method of claim 2, wherein flipping the one or more hard bits comprises:
repeatedly flipping two consecutive bits of the hard bits as originally generated, wherein a first bit of the two consecutive bits is indicated by the hypothesized bit error positions as representing a highest probability of a wrong binary decision in a descending order of probabilities, until the packet with the two consecutive bits flipped passes the CRC or until the hard bits indicated by each of the hypothesized bit error position are flipped without the packet with the two consecutive bits flipped passing the CRC.

7. The method of claim 2, wherein flipping the one or more hard bits comprises:
repeatedly flipping a single bit of the hard bits as originally generated, wherein the single bit is indicated by the hypothesized bit error positions as representing a highest probabilities of a wrong binary decision in a descending order of probabilities, until the packet with the single bit flipped passes the CRC or until the hard bits indicated by each of the hypothesized bit error position are flipped without the packet with the single bit flipped passing the CRC.

8. The method of claim 2, wherein flipping the one or more hard bits comprises:
flipping a first bit of the hard bits indicated by the hypothesized bit error positions as representing a highest probability of a wrong binary decision; and
flipping a second bit of the hard bits indicated by the hypothesized bit error positions as representing a next highest probability of a wrong binary decision.

9. The method of claim 1, wherein determining if the packet passes the CRC comprises:
determining an error syndrome of the packet, wherein the error syndrome of the packet indicates that the packet has at least one error bit in the hard bits;
generating one or more error syndromes corresponding to one or more error bits at the hypothesized bit error positions;
summing in an exclusive-or manner the error syndromes corresponding to the one or more error bits; and
determining that the error syndrome of the packet equals the summing of the error syndromes corresponding to the one or more error bits; and
flipping one or more of the hard bits indicated by the hypothesized bit error positions.

10. The method of claim 1, wherein the packet comprises a Bluetooth Low Energy (BLE) packet and wherein the soft bits comprise demodulated outputs of a BLE demodulator with decision feedback.

11. A receiver, comprising:
a wireless interface configured to receive one or more packets;
a processing device configured to perform operations comprising:
receive a packet to generate soft bits and corresponding hard bits for bits of the packet, the hard bits representing a binary decision for each of the bits based on the corresponding soft bits;
determine if the hard bits of the packet pass a cyclic redundancy check (CRC);
identify one or more hypothesized bit error positions for the bits of the packet based on the soft bits in responsive to determining that the hard bits of the packet fail the CRC;
flip one or more of the hard bits corresponding to the one or more hypothesized bit error positions; and
determine if the packet after said flip of the hard bits passes the CRC.

12. The receiver of claim 11, wherein the soft bits represent metrics to indicate a probability of a wrong decision for a corresponding one of the hard bits and wherein the hypothesized bit error positions indicate the hard bits representing one or more highest probabilities of a wrong binary decision in the packet.

13. The receiver of claim 12, wherein the processing device configured to flip one or more of the hard bits comprises the processing device configured to:
flip a first bit of the hard bits indicated by the hypothesized bit error positions as representing a highest probability of a wrong binary decision; and
flip a second bit of the hard bits immediately following the first bit.

14. The receiver of claim 13 wherein the processing device configured to determine if the packet after said flip of the hard bits passes the CRC comprises the processing device configured to:
determine that the packet after said flip of the first bit and the second bit still fails to pass the CRC;
un-flip the first bit and the second bit back to their binary decisions as originally generated;
flip a third bit of the hard bits indicated by the hypothesized bit error positions as representing a second highest probability of a wrong binary decision; and
flip a fourth bit of the hard bits immediately following the third bit.

15. The receiver of claim 13, wherein the processing device configured to determine if the packet after said flip of the hard bits passes the CRC comprises the processing device configured to:
determine that the packet after said flip of the first bit and the second bit still fails to pass the CRC;
un-flip the second bit back to its binary decision as originally generated; and
determine if the packet after said flip of only the first bit passes the CRC.

16. The receiver of claim 12, wherein the processing device configured to flip one or more of the hard bits comprises the processing device configured to:
repeatedly flip two consecutive bits of the hard bits as originally generated, wherein a first bit of the two consecutive bits is indicated by the hypothesized bit error positions as representing a highest probability of a wrong binary decision in a descending order of probabilities, until the packet with said flip of the two consecutive bits passes the CRC or until the hard bits indicated by each of the hypothesized bit error position are flipped without the packet with said flip of the two consecutive bits passing the CRC.

17. The receiver of claim 12, wherein the processing device configured to flip one or more of the hard bits comprises the processing device configured to:
repeatedly flip a single bit of the hard bits as originally generated, wherein the single bit is indicated by the hypothesized bit error positions as representing a highest probabilities of a wrong binary decision in a descending order of probabilities, until the packet with the single bit flipped passes the CRC or until the hard bits indicated by each of the hypothesized bit error position are flipped without the packet with the single bit flipped passing the CRC.

18. The receiver of claim 12, wherein the processing device configured to flip one or more of the hard bits comprises the processing device configured to:
flip a first bit of the hard bits indicated by the hypothesized bit error positions as representing a highest probability of a wrong binary decision; and
flip a second bit of the hard bits indicated by the hypothesized bit error positions as representing a next highest probability of a wrong binary decision.

19. The receiver of claim 11, wherein the processing device configured to determine if the packet passes the CRC comprises the processing device configured to:
determine an error syndrome of the packet, wherein the error syndrome of the packet indicates that the packet has at least one error bit in the hard bits;
generate one or more error syndromes corresponding to one or more error bits at the hypothesized bit error positions;
sum in an exclusive-or manner the error syndromes corresponding to the one or more error bits; and
determining that the error syndrome of the packet equals the sum of the error syndromes corresponding to the one or more error bits; and
flip one or more of the hard bits indicated by the hypothesized bit error positions.

20. A communication device, comprising:
one or more antennas configured to receive a packet;
a demodulator connected to the one or more antennas, the demodulator configured to:
generate soft bits and corresponding hard bits for bits of the packet, the hard bits representing a binary decision for each of the bits based on the corresponding soft bits; and
a processing device configured to:
determine if the hard bits of the packet pass a cyclic redundancy check (CRC);
identify one or more hypothesized bit error positions for the bits of the packet based on the soft bits in responsive to determining that the hard bits of the packet fail the CRC;
flip one or more of the hard bits corresponding to the one or more hypothesized bit error positions; and
determine if the packet after said flip of the hard bits passes the CRC.
